(19) United States
(12) Patent Application Publication
(10) Pub. No.: US 2008/0072024 A1
(43) Pub. Date: Mar. 20, 2008

(54) Predicting instruction branches with bimodal, little global, big global, and loop (BgGL) branch predictors

(76) Inventors: Mark C. Davis, Portland, OR (US); Robert Hinton, Hillsboro, OR (US); Boyd Phelps, Hillsboro, OR (US)

Correspondence Address: CAVEN & AGHEVLI;c/o INTELLEVATE, P.O. BOX 52050, MINNEAPOLIS, MN, 55402, US

(21) Appl. No.: 11/521,015

(22) Filed: Sep. 14, 2006

(51) Int. Cl. G06F 9/00

(52) U.S. Cl. 712/239

(57) ABSTRACT

Methods and apparatus to perform efficient branch prediction operations are described. In one embodiment, branch prediction may be performed by utilizing a combination of a bimodal predictor, a plurality of global predictors, and a loop predictor. Other embodiments are also described.

### BACKGROUND

The present disclosure generally relates to the field of electronics. More particularly, an embodiment of the invention relates to techniques for predicting branches in a processor by utilizing bimodal (B), little global (g), big global (G), and loop (L) branch predictors (which may be collectively referred to as a “BgGL” branch predictor).

To improve performance, some processors may utilize branch prediction. For example, when a computer processor encounters an instruction with a conditional branch, branch prediction may be used to predict whether the conditional branch will be taken and cause retrieval of the predicted instruction rather than waiting for the current instruction to be executed. As a result, branch prediction may eliminate the need to wait for the outcome of conditional branch instructions and therefore keep the processor pipeline as full as possible. Thus, branch prediction may be a significant contributor to processor performance.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1, 6, and 7 illustrate block diagrams of embodiments of computing systems, which may be utilized to implement various embodiments discussed herein.

FIG. 2 illustrates a block diagram of portions of a processor core and other components of a computing system, according to an embodiment of the invention.

FIG. 3 illustrates a block diagram of portions of a BgGL branch predictor, according to an embodiment.

FIGS. 4 and 5 illustrate flow diagrams of various methods in accordance with some embodiments of the invention.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable, instructions organized into one or more programs (“software”), or some combination of hardware and software. For the purposes of this disclosure reference to “logic” shall mean either hardware, software, or some combination thereof.

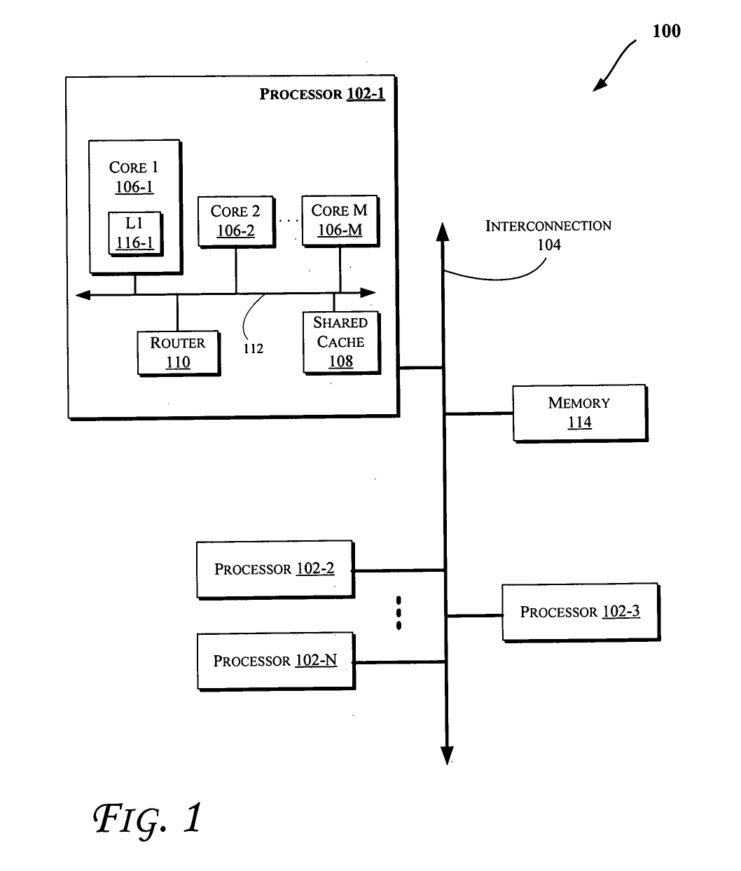

Some of the embodiments discussed herein may be utilized to perform efficient branch prediction in a processor. In an embodiment, branch prediction may be performed by utilizing a BgGL branch predictor. For example, a BgGL predictor may include four arrays (or predictor components) such as a bimodal predictor (B), a little (or small) global predictor (g), a big (or large) global predictor (G), and a loop predictor (L). Generally, an “array” as discussed herein may include a storage unit to store data corresponding to predictions. Further, the outputs of the four arrays may be combined to form a prediction in a prediction component of a processor, such as the processors discussed with reference to FIGS. 1 and 6-7. More particularly, FIG. 1 illustrates a block diagram of a computing system 100, according to an embodiment of the invention. The system 100 may include one or more processors 102-1 through 102-N (generally referred to herein as “processors 102” or “processor 102”). The processors 102 may communicate via an interconnection network or bus 104. Each processor may include various components some of which are only discussed with reference to processor 102-1 for clarity. Accordingly, each of the remaining processors 102-2 through 102-N may include the same or similar components discussed with reference to the processor 102-1.

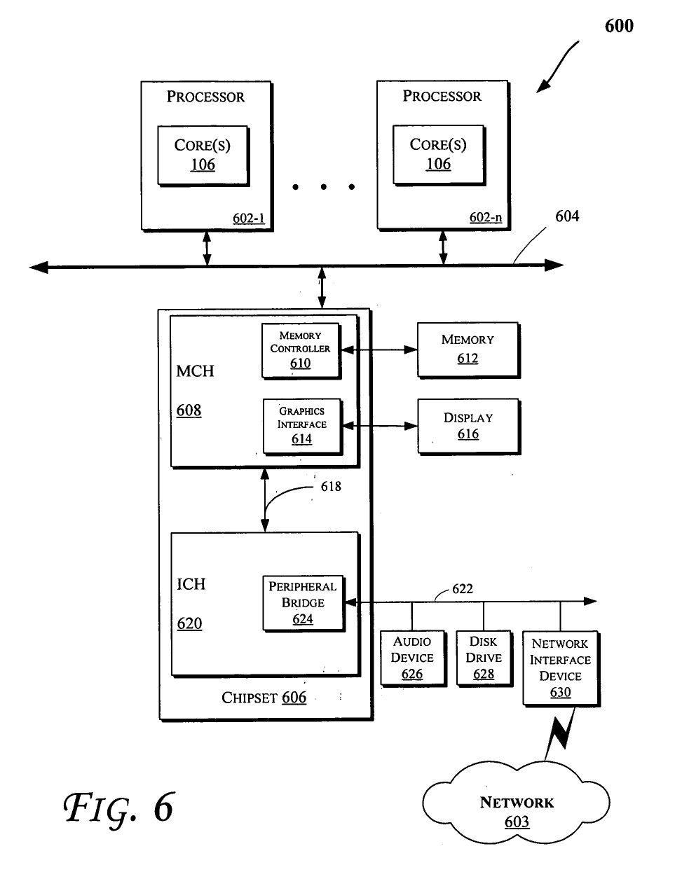

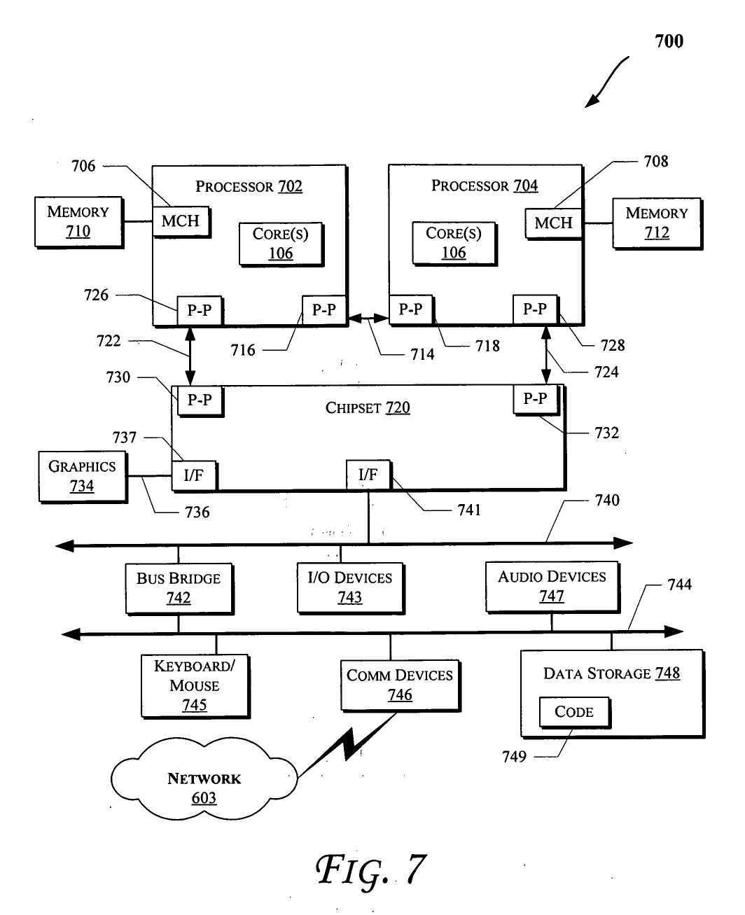

In an embodiment, the processor 102-1 may include one or more processor cores 106-1 through 106-M (referred to herein as “cores 106” or more generally as “core 106”), a shared cache 108, and/or a router 110. The processor cores 106 may be implemented on a single integrated circuit (IC) chip. Moreover, the chip may include one or more shared and/or private caches (such as cache 108), buses or interconnections (such as a bus or interconnection network 112), memory controllers (such as those discussed with reference to FIGS. 6 and 7), or other components.

In one embodiment, the router 110 may be used to communicate between various components of the processor 102-1 and/or system 100. Moreover, the processor 102-1 may include more than one router 110. Furthermore, the multitude of routers (110) may be in communication to enable data routing between various components inside or outside of the processor 102-1.

The shared cache 108 may store data (e.g., including instructions) that are utilized by one or more components of the processor 102-1, such as the cores 106. For example, the shared cache 108 may locally cache data stored in a memory 114 for faster access by components of the processor 102. In an embodiment, the cache 108 may include a mid-level cache (such as a level 2 (L2), a level 3 (L3), a level 4 (L4), or other levels of cache), a last level cache (LLC), and/or combinations thereof. Moreover, various components of the processor 102-1 may communicate with the shared cache 108 directly, through a bus (e.g., the bus 112), and/or a memory controller or hub. As shown in FIG. 1, in some embodiments, one or more of the cores 106 may include a level 1 (L1) cache (116-1) (generally referred to herein as “L1 cache 116”).

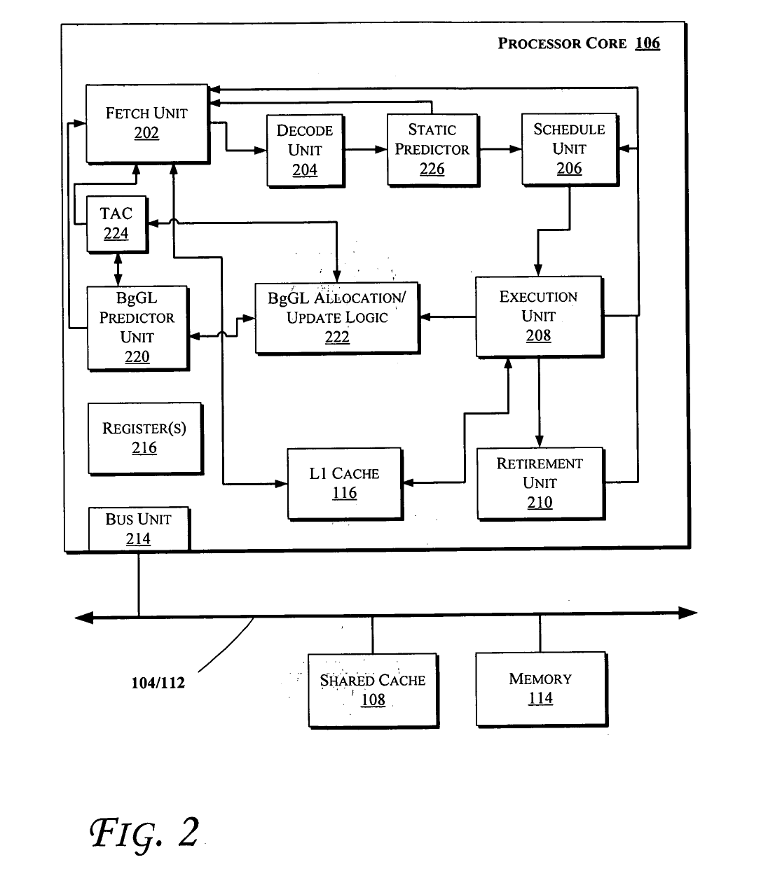

FIG. 2 illustrates a block diagram of portions of a processor core 106 and other components of a computing system, according to an embodiment of the invention. In one embodiment, the arrows shown in FIG. 2 illustrate the flow direction of instructions through the core 106. One or more processor cores (such as the processor core 106) may be implemented on a single integrated circuit chip (or die) such as discussed with reference to FIG. 1. Moreover, the chip may include one or more shared and/or private caches (e.g., cache 108 of FIG. 1), interconnections (e.g., interconnections 104 and/or 112 of FIG. 1), memory controllers, or other components.

As illustrated in FIG. 2, the processor core 106 may include a fetch unit 202 to fetch instructions (including instructions with conditional branches) for execution by the core 106. The instructions may be fetched from any storage devices such as the memory 114 and/or the memory devices discussed with reference to FIGS. 6 and 7. The core 106 may also include a decode unit 204 to decode the fetched instruction. For instance, the decode unit 204 may decode the fetched instruction into a plurality of uops (micro-operations). Additionally, the core 106 may include a schedule unit 206. The schedule unit 206 may perform various operations associated with storing decoded instructions (e.g., received from the decode unit 204) until the instructions are ready for dispatch, e.g., until all source values of a decoded instruction become available. In one embodiment, the schedule unit 206 may schedule and/or issue (or dispatch) decoded instructions to an execution unit 208 for execution. The execution unit 208 may execute the dispatched instructions after they are decoded (e.g., by the decode unit 204) and dispatched (e.g., by the schedule unit 206). In an embodiment, the execution unit 208 may include more than one execution unit, such as a jump execution unit (JEU). In one embodiment, a branch may be resolved at execution (e.g., by a component of the jump execution unit) and used to update and/or allocate branches in a BgGL allocation and update logic 222. In one embodiment, a BgGL predictor unit 220 may utilize the results of one or more operations performed by BgGL allocation/update logic 222 to more accurately predict future branches. The execution unit 208 may also perform various arithmetic operations such as addition, subtraction, multiplication, and/or division, and may include one or more an arithmetic logic units (ALUs). In an embodiment, a co-processor (not shown) may perform various arithmetic operations in conjunction with the execution unit 208.

Further, the execution unit 208 may execute instructions out-of-order. Hence, the processor core 106 may be an out-of-order processor core in one embodiment. The core 106 may also include a retirement unit 210. The retirement unit 210 may retire executed instructions after they are committed. In an embodiment, retirement of the executed instructions may result in processor state being committed from the execution of the instructions, physical registers used by the instructions being de-allocated, etc. In an embodiment, the retirement unit 210 may resolve branches by utilizing the BgGL allocate and update logic 222.

The core 106 may also include a bus unit 214 to enable communication between components of the processor core 106 and other components (such as the components discussed with reference to FIG. 1) via one or more buses (e.g., buses 104 and/or 112). The core 106 may also include one or more registers 216 to store data accessed by various components of the core 106.

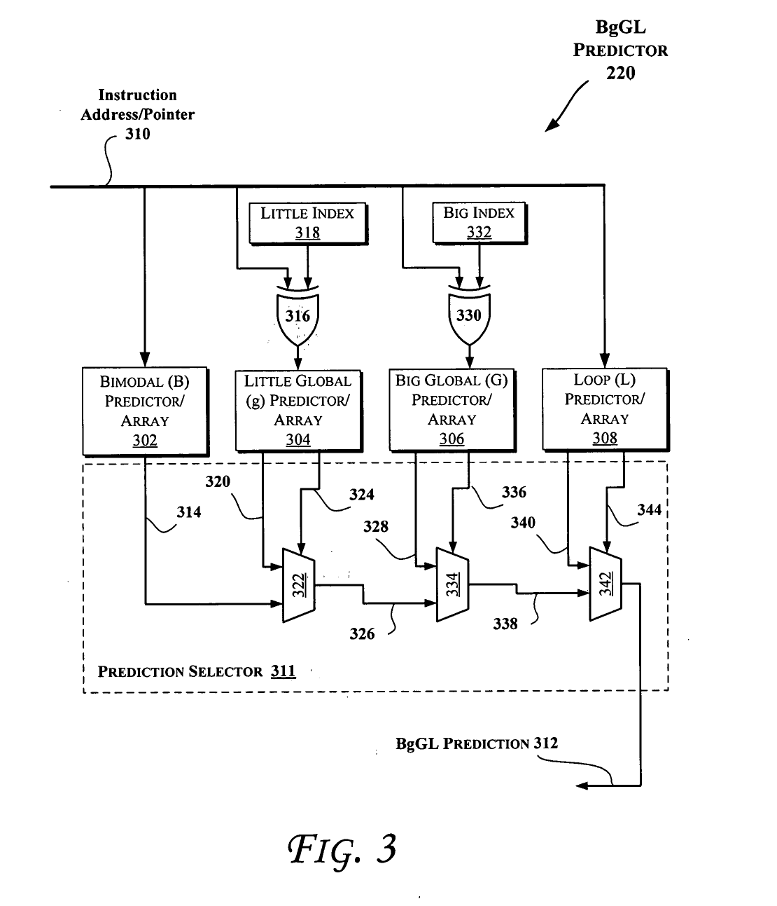

As illustrated in FIG. 2, the core 106 may include the BgGL branch predictor 220 to form a prediction regarding an instruction with a conditional or unconditional branch that is fetched from a storage unit such as the cache 108, cache 116, and/or memory 114. BgGL branch predictor 220 may communicate with a target address calculator (TAC) array or storage unit 224 to obtain branch target, branch type, branch instruction location, and other information that may be needed to make predictions. Furthermore, the BgGL branch predictor 220 may receive signals corresponding to the results of a static prediction from the static predictor 226. In an embodiment, the branch predictor 220 may predict whether a branch corresponding to a current instruction will be taken and cause retrieval of the predicted instruction (e.g., by the fetch unit 202), rather than having the processor core 106 wait for the current instruction to be executed or execute down the wrong path. As a result, the branch predictor 220 may eliminate the need to wait for the outcome of conditional branch instructions and therefore keep the pipeline of the processor core 106 as full as possible. For example, if the processor core 106 executed incorrectly down the wrong path, the branch predictor 220 may eliminate the need for a full pipeline flush when the execution unit 208 potentially detects a misprediction. Additionally, the execution unit 208 may include an allocate and/or update logic 222. For example, the logic 222 may allocate entries (or generate new entries) in prediction arrays (such as arrays 302-308 discussed with reference to FIG. 3) in response to branch misprediction. Also, the logic 222 may update data corresponding to one or more current predictions based on an actual outcome of a branch prediction. Furthermore, the logic 222 may be provided in various locations within the core 106, such as within the retirement unit 210 and/or the execution unit 208.

FIG. 3 illustrates a block diagram of portions of the BgGL branch predictor 220 of FIG. 2, according to an embodiment. The predictor 220 may include a bimodal (B) predictor 302, one or more global predictors (e.g., including a little global (g) predictor 304 and a big global (G) predictor 306), and a loop (L) predictor 308. Each of the predictors 302-308 may also include a storage unit to store a corresponding array of entries (which may be tagged in some embodiments) to assist in predicting branches. Moreover, each of the predictors 302-308 may receive an instruction pointer (or instruction address) 310 corresponding to a conditional branch instruction whose branch is being predicted. For example, a portion of the instruction pointer 310 may be utilized by the predictors 302-308 to generate branch predictions. The predictor 220 may further include a prediction selector 311 to select a branch prediction signal 312 based on various signals.

As shown in FIG. 3, the bimodal predictor 302 may generate a bimodal prediction signal 314, e.g., indexed with the instruction pointer (IP) 310. The predictor 302 may store state of an n-bit counter assigned to the branch instruction (310) or a set of branch instructions. In an embodiment, the bimodal branch predictor 302 may have a table of two-bit entries, e.g., indexed with the least significant m-bits of the instruction addresses. In some embodiments, the bimodal predictor entries may not have tags, and so a particular counter may be mapped to different branch instructions (this is called branch interference or branch aliasing). Branch aliasing may occur when the IP 310 has the same m least significant bits, where m=log 2 (number of entries in bimodal table). In one embodiment, where n=2, each counter may have one of four states: strongly not taken, weakly not taken, weakly taken, or strongly taken. In one embodiment, the counter bits may be shared among multiple branch IPs (310) or entries in the table.

Further, the little global predictor 304 may receive the output of an exclusive OR (XOR) gate 316 which generates a signal based on the instruction pointer 310 and a little index (or stews) 318. In turn, the predictor 304 may generate a little global prediction signal 320, e.g., by indexing the little global array based on the output of XOR 316 and reading the content of the little global array at that address. Generally, a global branch predictor (such as the global predictors 304 and/or 306) may generate a prediction signal based on the knowledge that the behavior of some branches may be correlated with the history of other recently taken branches. In one embodiment, the stew or little index is based on information from both the IP (310) and global branch history. Moreover, a multiplexer 322 may select one of the predictions 314 or 320 based on a selection signal 324 to generate an intermediate prediction signal 326. In one embodiment, in the presence of a little global selection signal (324), which may be asserted when a hit is detected in the array 304, the little global prediction signal 320 may be selected over a bimodal prediction signal (314) by the prediction selector 311.

Additionally, the big global predictor 306 may generate a big global prediction signal (328) based on the content of the big global array using an index of an exclusive OR (XOR) gate 330 (which generates a signal based on the instruction pointer 310 and a big index (or stew) 332). The global predictors 304 and 306 may predict whether the branch will be taken according to an index or “stew” (318 or 332), which may be based on the instruction address and information from global branch history. In an embodiment, a different set of global branch history data may be used for each of the predictors 304 and 306 (with the set for the little global branch predictor 304 being smaller, for example). The length of the global branch history data may determine how much correlation may be captured by the global predictors. Accordingly, global predictors may be used, in part, because branch instructions sometimes have the tendency to correlate to other nearby instructions. Furthermore, in some embodiments, entries of the global predictors 304 and 306 may include tags, and so a particular entry may be mapped to a particular branch instruction (which may eliminate branch interference or branch aliasing up to the number of bits (p), where p=number of bits in set+number of bits in the tag). In one embodiment, the number of set bits may correspond to log 2 (number of entries) of the array as it is indexed with the least significant bits.

As illustrated in FIG. 3, a multiplexer 334 may select one of the predictions 326 or 328 based on a selection signal 336 to generate an intermediate prediction signal 338. In one embodiment, if a big global prediction signal (328) is present, as indicated by a hit in big global array 306, the prediction selector 311 may select it over a little global prediction signal (326) (and the bimodal prediction signal (314)).

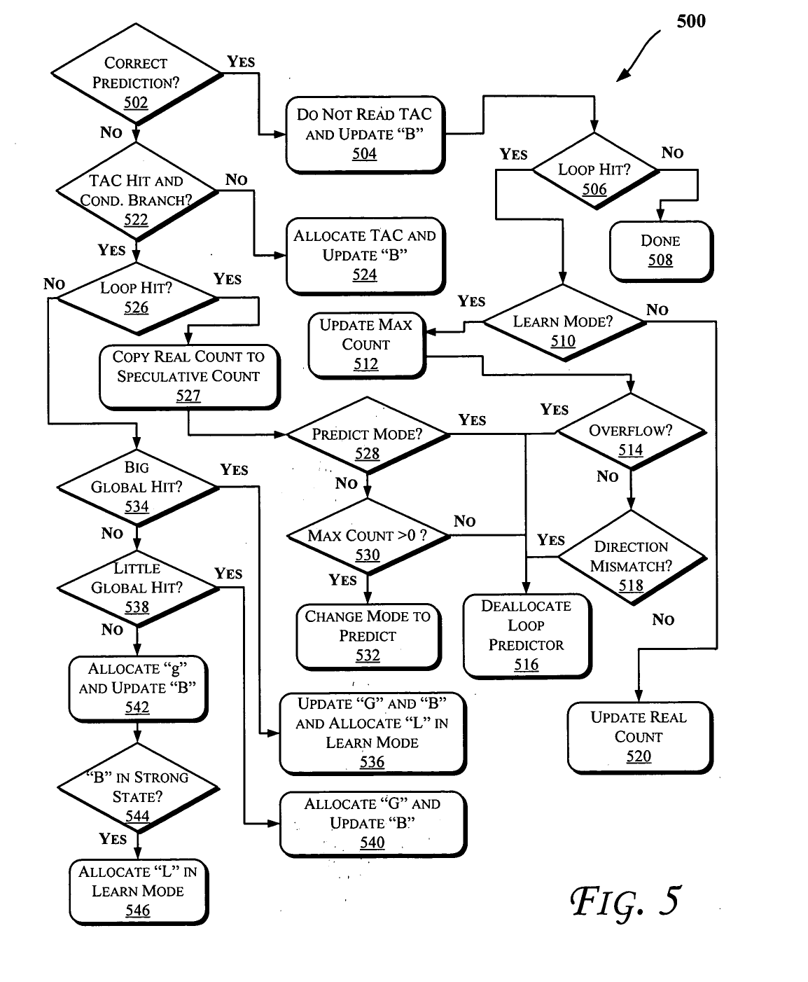

Also, the loop predictor 308 may generate a loop prediction signal 340 based on the instruction pointer 310 and the content of the loop array. The loop predictor 308 may analyze branches to determine whether they have loop behavior. Loop behavior is defined as moving in one direction (taken or not-taken) a fixed number of times interspersed with a single movement in the opposite direction. When such a branch is detected, a set of counters may be allocated in the predictor 308 such that the behavior of the program may be predicted completely accurately for larger iteration counts than typically captured by global, history-based predictors (such as the predictors 304 and 306), or in cases where the history based predictors alias and are unable to accurately predict this loop branch. As will be further discussed here, e.g., with reference to FIG. 5, both the little global predictor 304 and the big global predictor 306 may also predict loops, so in some embodiments, the corresponding entry in the loop predictor 308 may be deallocated. In one embodiment, as the selection for the prediction signal 312 moves from the predictions generated by the bimodal predictor 302 to little global predictor 304, and little global predictor 304 to big global predictor 306, and big global predictor 306 to loop predictor 308, branches may be filtered through the preceding predictor. In an embodiment, this may allow for a decrease in the size of the predictors down the hierarchy. To this end, the loop predictor 308 may be de-allocated when another predictor may be able to correctly predict a branch for efficiency. In one embodiment, the relatively fast path loop allocation discussed herein, e.g., with reference to FIG. 5, allows the loop predictor 308 to potentially predict a loop branch before the big global predictor 306 has a chance to do so.

Furthermore, as shown in FIG. 3, a multiplexer 342 may select one of the predictions 338 or 340 based on a selection signal 344 to generate the BgGL prediction signal 312. In one embodiment, if a loop selection signal (344) is present, indicating a hit has occurred in the loop predictor array, which is operating in predict mode, the prediction selector 311 may select it over other predictions (such as the global predictions (320 and 328) and the bimodal prediction signal 314).

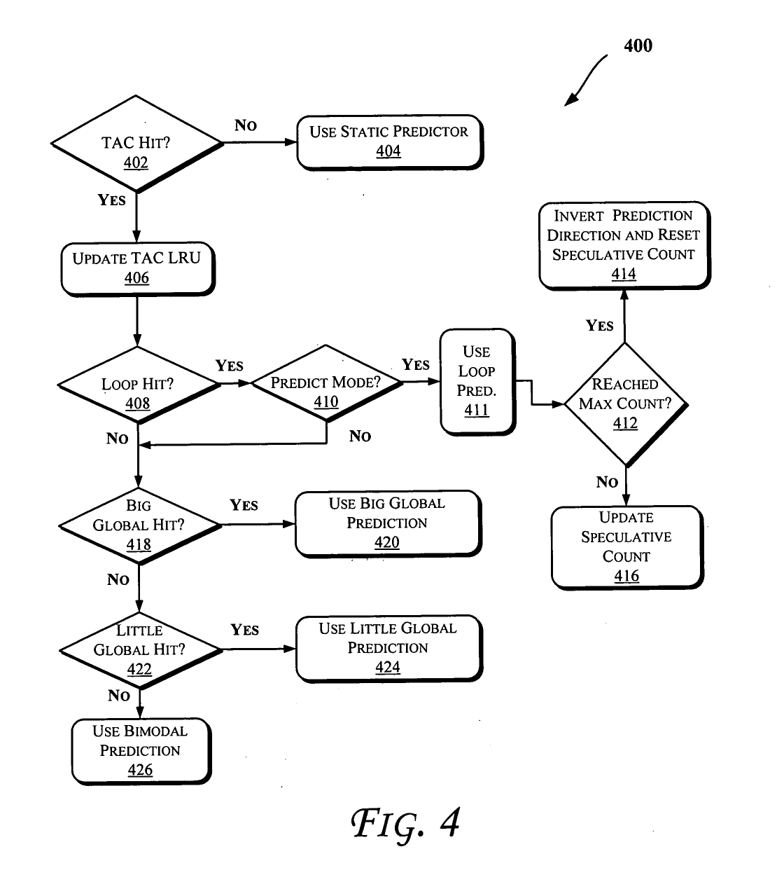

FIG. 4 illustrates a flow diagram of a method 400 to predict the outcome of a conditional or unconditional branch instruction (which was once taken), according to an embodiment. In some embodiments, various components discussed with reference to FIGS. 1-3 and 6-7 may be utilized to perform one or more of the operations discussed with reference to FIG. 4. For example, one or more of the components of the BgGL branch predictor 220 and TAC 224 of FIG. 2 (which may also be referred to generically as a “target address array”) may be used to perform at least some of the operations discussed with reference to FIG. 4.

Referring to FIGS. 1-4, at an operation 402, it may be determined whether a hit has occurred in a TAC (e.g., the TAC 224 may determine whether a hit has occurred in a TAC 224). In particular, all predictions generated by the predictors 302-308 (e.g., signals 314, 320, 328, or 340) may be invalid unless a hit is made in a tagged target array (such as TAC 224). Moreover, the TAC 224 may provide the address for the target of the branch instruction. Therefore, if a target address is absent for the branch instruction at operation 402, a static predictor (e.g., the predictor 226) may be used to generate a static prediction signal at operation 404, e.g., using information provided by decode unit 204. For example, the static predictor 226 may predict that backward-pointing branches will be taken (assuming that the backwards branch is the bottom of a program loop) and forward-pointing branches will not be taken.

After a hit in the TAC at operation 402, the least recently used (LRU) algorithm of the TAC (e.g., the TAC 224) may be updated at an operation 406. For example, the LRU may be how different ways within a set of an associative array (such as the TAC 224 array) are replaced. Furthermore, in an embodiment, operation 406 may be performed at predict time (e.g., by the TAC 224), because the TAC may not be updated at execution (208) or retirement (210) when a branch is predicted correctly. If a prediction is correct at update time, an update (e.g., by the update logic 222) may not be performed on a TAC entry by having to access the TAC 224, e.g., thus reducing power consumption associated with accessing the TAC 224.

At an operation 408, if a hit in a loop array (e.g., the loop array 308) occurs (e.g., as indicated by the signal 344 and the loop predictor 308 is in “predict” mode at operation 410), the loop prediction may be used (e.g., the predictor 220 may use the loop prediction signal 340 as the branch prediction signal 312) at an operation 411. Further, at operation 412, it is determined whether a maximum loop count is reached. For example, the value of a speculative count (that may be maintained by the loop predictor 308, within BgGL predictor unit 220) may be compared with the maximum count to determine whether the loop has reached its maximum number of iterations. If the maximum count is reached, the direction of prediction for the loop predictor 308 may be inverted or reversed and the value of the speculative count may be reset at an operation 414. Otherwise, the direction of the prediction for the loop predictor (e.g., the loop predictor 308) is not inverted and is used as stored, and the value of the speculative count may be updated at operation 416 (e.g., incremented or decremented depending on the implementation). One embodiment increments the counts and compares them to a maximum count, while another embodiment may decrement counts as iterations are performed and compare them to zero. The later implementation may be performed by properly initializing the initial speculative count based on the number of expected iterations in the loop.

After operations 408 and 410 (if a miss occurs in the loop array or the loop predictor 308 is in “learn” mode, respectively), if a hit in a big global array (e.g., the array 306) occurs (e.g., as indicated by the signal 336) at an operation 418, the predictor (e.g., the predictor 220) may utilize a big global prediction signal (e.g., signal 328) as the branch prediction (e.g. as signal 312) at an operation 420. Further, if a miss occurs in the big global array (at operation 418), and if a hit in a little global array (e.g., the array 304) occurs (e.g., as indicated by the signal 324) at an operation 422, the predictor (e.g., predictor 220) may utilize the little global prediction signal (e.g., signal 320) as the branch prediction signal (e.g., signal 312) at an operation 424. And, if a miss occurs in the little global array (at operation 422), the predictor (e.g., predictor 220) may utilize the bimodal prediction signal (e.g., signal 314) as the branch prediction signal (e.g., signal 312) at operation 426. In an embodiment, q-bit counters record states of predictions. If q=2, states may be: weak taken=state 10, strong taken=state 11, weak not-taken=state 01, and strong not-taken=state 00), in the predictors 302-308. In an embodiment where q=2, the most significant bit of the two-bit counters may be used to determine whether the prediction is taken or not-taken. In an embodiment, tags in predictors 304-308 may indicate whether a hit or miss has occurred at operations 408, 418, and/or 422.

In some embodiments, FIGS. 3 and 4 illustrate that the final prediction signal 312 may be taken from a combination of the four predictors 302-308. For example, if the loop predictor 308 has a tag hit in “predict” mode, it overrides all other predictors. Next, if the big global predictor 306 has a hit and the loop predictor 308 missed or hit and was in “learn” mode, the big global predictor 306 generates the prediction. If both the big global predictor 306 and loop predictor 308 miss or is in “learn” mode, and the little global predictor 304 hits, the little global predictor 304 determines the prediction. The bimodal predictor 302 may not be tagged in an embodiment and may serve as the default prediction when all other arrays miss.

FIG. 5 illustrates a flow diagram of a method 500 to allocate and/or update various data corresponding to branch prediction operations, according to an embodiment. In some embodiments, various components discussed with reference to FIGS. 1-3 and 6-7 may be utilized to perform one or more of the operations discussed with reference to FIG. 5. For example, one or more of the components of the execution unit 208 of FIG. 2, and/or BgGL allocation/update logic 222 of FIG. 2, and/or TAC 224 of FIG. 2, and/or the BgGL branch predictor unit 220 of FIG. 2 may be used to perform at least some of the operations discussed with reference to FIG. 5. Further, in an embodiment, some of the allocation schemes discussed with reference to FIG. 5 are aimed to allocate the simplest and/or most accurate predictor (e.g., from the predictors 302-308) for each branch instruction. Additionally, some allocate and/or update schemes may serve to minimize aliasing between predictors.

Referring to FIGS. 1-5, at an operation 502, if a prediction is correct (e.g., as determined by the execution unit 208), a TAC (e.g., TAC 224) is not accessed and a corresponding entry in a bimodal predictor (e.g., predictor 302) may be updated at operation 504. Further, at an operation 506, if a miss occurs in a loop array (e.g., as indicated by the signal 344), the method 500 terminates without further action at operation 508. If a hit occurs in the loop array instead, at an operation 510, it is determined whether the loop predictor (e.g., the predictor 308) is in “learn” mode. If the loop predictor (e.g., the predictor 308) is in “learn” mode, the maximum count is updated at operation 512 (e.g., incremented or decremented depending on the implementation). After operation 512, an operation 514 may determine whether an overflow condition has occurred. In an embodiment, an overflow condition at operation 514 indicates that the loop iteration count has reached the limit of the counters, as defined by 2ⁿ⁻¹, where n is the number of bits. Thus, for example, six-bit counters may allow a loop of up to 63 iterations, but will flip to 0 on the 64^{th} iteration. If an overflow has occurred (e.g., in the loop predictor 308), the corresponding entry may be deallocated from the loop array at operation 516. If an overflow condition is absent at operation 514, it may be determined whether the actual resolved direction, determined by the JEU unit within the execution unit 208, in one embodiment, was operating in an opposite direction from the stored direction in the loop predictor at operation 518. If so, the method 500 may continue with operation 516, which will de-allocate the loop predictor entry. In this case, it may have been detected that another branch predictor has correctly predicted this branch and would prefer to leverage other less-costly predictors when possible. Generally, both real and maximum count may be positioned to update at execution time, whereas a count at predict time may be referred to as a speculative count. The maximum count is accessed and/or updated when the loop predictor is in “learn” mode and is capturing the length of a potential loop. The real count is updated when executing a loop branch, and is maintained so recovery from other branch instruction clears may occur. The speculative count is updated at predict, e.g., to enable precise detection of the final iteration of the loop, before it reaches the backend stages of the pipeline. As shown in FIG. 5, if the loop predictor 308 is in “predict” mode at operation 510, the method 500 may continue with the operation 520, which will update the real count.

At operation 502, if a misprediction occurs, an operation 522 may determine whether a hit in the TAC (e.g., the TAC 224) has occurred and further whether the corresponding instruction is a conditional branch instruction. In an embodiment, the TAC 224 may store various data for each instruction including a target address and a corresponding branch type. Thus, operation 522 may be performed by reference to the TAC 224. If a miss occurs in the TAC or the branch type is not conditional, an entry corresponding to the instruction may be allocated in the TAC (e.g., TAC 224) and a bimodal array (e.g., the array 302) may be updated at an operation 524.

If a hit in the TAC (e.g., TAC 224) occurs and the instruction corresponds to a conditional branch at operation 522, operation 527 may copy the contents of the loop predictor real counts to speculative counts, in one embodiment. The copying operation may allow BgGL predictor unit 220 to recover from branch mispredictions, as the speculative counts are now corrupt. In one embodiment, other forms of pipeline clears may also repair the speculative loop counts, as to allow them to recover. One example of another form of pipeline clear would be a memory disambiguation clear or “nuke.” If a hit in the TAC (e.g., TAC 224) occurs and the instruction corresponds to a conditional branch at operation 522, upon a hit in a loop array (e.g., array 308) at operation 526, it may be determined whether the loop predictor (e.g., predictor 308) is in “predict” mode at an operation 528. If the loop predictor (e.g., predictor 308) is in “predict” mode, the method 500 continues with operation 516, which will de-allocate the loop from the BgGL predictor unit (e.g., the predictor unit 220). Otherwise, if the loop predictor (e.g., predictor 308) is in “learn” mode, an operation 530 may determine whether the maximum count is larger than zero. If the maximum count is at zero at operation 530, the method 500 continues with operation 516 to de-allocate the loop prediction from the loop predictor (e.g. predictor 308). If the maximum count is larger than zero (for example, indicating the loop predictor has learned one or more iterations of the loop already), the mode of the loop predictor (e.g., the loop predictor 308) may be changed from “learn” to “predict”, in one embodiment of operation 532. At operation 532, the value of the maximum count represents the correct number of iterations of the loop. In one embodiment, operation 532 may also initialize the speculative loop counter to zero, when the counter is incremented as loops are detected by BgGL predictor unit 220. In another embodiment, the initialization may set the speculative count equal to the maximum count, and each iteration decrements the speculative counter in BgGL predictor unit 220. In accordance with at least one instruction set architecture, the operation 532 may be performed in response to a jump execution clear (JEclear).

Upon a miss in the loop array (e.g., the array 308) at operation 526, at an operation 534, if a hit in a big global array (e.g., the array 306) occurs, the big global array (e.g., the array 306) and a bimodal array (e.g., array 302) may be updated, and an entry may be allocated in the loop array (e.g., array 308) with the loop predictor in “learn” mode at operation 536. Alternatively, if a miss occurs in the big global array (e.g., array 306) at operation 534, upon a hit in the little global array (e.g., array 304) at an operation 538, an entry may be allocated in the big global array (e.g., array 306) and the bimodal, array (e.g., array 302) may be updated at an operation 540. Further, if a miss occurs at operation 538, a corresponding entry may be allocated in the little global array (e.g., array 304) and the bimodal array (e.g., array 302) may be updated at an operation 542.

At an operation 544, if the bimodal array (e.g., array 302) indicates a strong state (e.g., strongly taken or strongly not taken), at an operation 546, an entry may be allocated in the loop array (e.g., array 308) and the loop predictor's mode may be set to “learn” mode. Hence, when an entry in the little global array 304 is allocated (e.g., at operation 542), an entry in the loop array 308 may also be allocated (e.g., assuming the bimodal array 302 is in strong state) in an embodiment. This allows for a relatively fast allocation path, in part, because the learning process and learn to predict mode transition timing of the loop predictor 308 may be accelerated.

FIG. 6 illustrates a block diagram of a computing system 600 in accordance with an embodiment of the invention. The computing system 600 may include one or more central processing unit(s) (CPUs) 602 or processors that communicate via an interconnection network (or bus) 604. The processors 602 may include a general purpose processor, a network processor (that processes data communicated over a computer network 603), or other types of a processor (including a reduced instruction set computer (RISC) processor or a complex instruction set computer (CISC)). Moreover, the processors 602 may have a single or multiple core design. The processors 602 with a multiple core design may integrate different types of processor cores on the same integrated circuit (IC) die. Also, the processors 602 with a multiple core design may be implemented as symmetrical or asymmetrical multiprocessors. In an embodiment, one or more of the processors 602 may be the same or similar to the processors 102 of FIG. 1. For example, one or more of the processors 602 may include one or more of the cores 106 discusses with reference to FIGS. 1 and/or 2. Also, the operations discussed with reference to FIGS. 1-5 may be performed by one or more components of the system 600.

A chipset 606 may also communicate with the interconnection network 604. The chipset 606 may include a memory control hub (MCH) 608. The MCH 608 may include a memory controller 610 that communicates with a memory 612 (which may be the same or similar to the memory 114 of FIG. 1). The memory 612 may store data, including sequences of instructions, that may be executed by the CPU 602, or any other device included in the computing system 600. In one embodiment of the invention, the memory 612 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 604, such as multiple CPUs and/or multiple system memories.

The MCH 608 may also include a graphics interface 614 that communicates with a display device 616. In one embodiment of the invention, the graphics interface 614 may communicate with the display device 616 via an accelerated graphics port (AGP). In an embodiment of the invention, the display 616 (such as a flat panel display) may communicate with the graphics interface 614 through, for example, a signal converter that translates a digital representation of an image stored in a storage device such as video memory or system memory into display signals that are interpreted and displayed by the display 616. The display signals produced by the display device may pass through various control devices before being interpreted by and subsequently displayed on the display 616.

A hub interface 618 may allow the MCH 608 and an input/output control hub (ICH) 620 to communicate. The ICH 620 may provide an interface to I/O device(s) that communicate with the computing system 600. The ICH 620 may communicate with a bus 622 through a peripheral bridge (or controller) 624, such as a peripheral component interconnect (PCI) bridge, a universal serial bus (USB) controller, or other types of peripheral bridges or controllers. The bridge 624 may provide a data path between the CPU 602 and peripheral devices. Other types of topologies may be utilized. Also, multiple buses may communicate with the ICH 620, e.g., through multiple bridges or controllers. Moreover, other peripherals in communication with the ICH 620 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 622 may communicate with an audio device 626, one or more disk drive(s) 628, and a network interface device 630 (which is in communication with the computer network 603). Other devices may communicate via the bus 622. Also, various components (such as the network interface device 630) may communicate with the MCH 608 in some embodiments of the invention. In addition, the processor 602 and the MCH 608 may be combined to form a single chip. Furthermore, the graphics accelerator 616 may be included within the MCH 608 in other embodiments of the invention.

Furthermore, the computing system 600 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 628), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

FIG. 7 illustrates a computing system 700 that is arranged in a point-to-point (PtP) configuration, according to an embodiment of the invention. In particular, FIG. 7 shows a system where processors, memory, and input/output devices are interconnected by a number of point-to-point interfaces. The operations discussed with reference to FIGS. 1-6 may be performed by one or more components of the system 700.

As illustrated in FIG. 7, the system 700 may include several processors, of which only two, processors 702 and 704 are shown for clarity. The processors 702 and 704 may each include a local memory controller hub (MCH) 706 and 708 to enable communication with memories 710 and 712. The memories 710 and/or 712 may store various data such as those discussed with reference to the memory 612 of FIG. 6.

In an embodiment, the processors 702 and 704 may be one of the processors 602 discussed with reference to FIG. 6. The processors 702 and 704 may exchange data via a point-to-point (PtP) interface 714 using PtP interface circuits 716 and 718, respectively. Also, the processors 702 and 704 may each exchange data with a chipset 720 via individual PtP interfaces 722 and 724 using point-to-point interface circuits 726, 728, 730, and 732. The chipset 720 may further exchange data with a graphics circuit 734 via a graphics interface 736, e.g., using a PtP interface circuit 737.

At least one embodiment of the invention may be provided within the processors 702 and 704. For example, one or more of the cores 106 of FIGS. 1-2 may be located within the processors 702 and 704. Other embodiments of the invention, however, may exist in other circuits, logic units, or devices within the system 700 of FIG. 7. Furthermore, other embodiments of the invention may be distributed throughout several circuits, logic units, or devices illustrated in FIG. 7.

The chipset 720 may communicate with a bus 740 using a PtP interface circuit 741. The bus 740 may communicate with one or more devices, such as a bus bridge 742 and I/O devices 743. Via a bus 744, the bus bridge 742 may communicate with other devices such as a keyboard/mouse 745, communication devices 746 (such as modems, network interface devices, or other communication devices that may communicate with the computer network 603), audio I/0 device 747, and/or a data storage device 748. The data storage device 748 may store code 749 that may be executed by the processors 702 and/or 704.

In various embodiments of the invention, the operations discussed herein, e.g., with reference to FIGS. 1-7, may be implemented as hardware (e.g., logic circuitry), software, firmware, or combinations thereof, which may be provided as a computer program product, e.g., including a machine-readable or computer-readable medium having stored thereon instructions (or software procedures) used to program a computer to perform a process discussed herein. The machine-readable medium may include a storage device such as those discussed with respect to FIGS. 1-7.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a bus, a modem, or a network connection). Accordingly, herein, a carrier wave shall be regarded as comprising a machine-readable medium.

Reference in the specification to “one embodiment,” “an embodiment,” or “some embodiments” means that a particular feature, structure, or characteristic described in connection with the embodiment(s) may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A processor comprising:
a first logic to generate a first global prediction signal corresponding to a branch instruction;
a second logic to generate a second global prediction signal corresponding to the branch instruction;
a third logic to generate a bimodal prediction signal corresponding to the branch instruction; and
a fourth logic to generate a loop prediction signal corresponding to the branch instruction.

2. The processor of claim 1, further comprising a target address calculator (TAC) storage unit to store one or more of a branch target, a branch type, or a location of the branch instruction.

3. The processor of claim 1, further comprising a fifth logic to update data in at least one storage unit coupled to the first logic, the second logic, the third logic, or the fourth logic based on presence of a branch target in a target address calculator storage unit.

4. The processor of claim 1, further comprising a fifth logic to select a branch prediction signal from one of: the first global prediction signal, the second global prediction signal, the bimodal prediction signal, or the loop prediction signal.

5. The processor of claim 4, wherein the fifth logic comprises:
a first multiplexer to generate a first intermediate prediction signal based on the bimodal prediction signal, the first global prediction signal, and whether a hit has occurred in a first global prediction array coupled to the first logic;
a second multiplexer to generate a second intermediate prediction signal based on the first intermediate prediction signal, the second global prediction signal, and whether a hit has occurred in a second global prediction array coupled to the second logic; and
a third multiplexer to select the branch prediction signal based on the second intermediate prediction signal, the loop prediction signal, and whether a hit has occurred in a third loop prediction array coupled to the third logic.

6. The processor of claim 1, further comprising a fifth logic to deallocate an entry from a loop prediction array coupled to the fourth logic in response to one or more of a loop counter overflow, a zero length loop, or a misprediction.

7. The processor of claim 1, further comprising a fifth logic to allocate one or more entries corresponding to the branch instruction in one or more storage units coupled to the first logic, the second logic, the third logic, or the fourth logic in response to a branch misprediction.

8. The processor of claim 1, further comprising a fifth logic to recover a speculative loop iteration count in response to one or more events that cause data to be cleared from at least one component of the processor.

9. The processor of claim 1, further comprising a fifth logic to update data corresponding to one or more current predictions based on an outcome of a branch prediction corresponding to the branch instruction.

10. The processor of claim 9, wherein the fifth logic causes power consumption to be reduced in response to occurrence of a correct prediction by refraining from accessing one or more entries in a target address calculator storage unit.

11. The processor of claim 1, wherein the first logic generates the first global prediction signal based on a first set of global branch history data and the second logic generates the second global prediction signal based on a second set of global branch history data.

12. The processor of claim 11, wherein the first set of global branch history data is smaller than the second set of global branch history data.

13. The processor of claim 1, further comprising a fifth logic to generate a static prediction signal corresponding to the branch instruction.

14. The processor of claim 1, further comprising a plurality of processor cores, wherein at least one of the plurality of processor cores comprises one or more of the first logic, the second logic, the third logic, or the fourth logic.

15. The processor of claim 1, wherein the fourth logic is to learn a loop count based on a misprediction signal, wherein the misprediction signal is to be generated at update time.

16. The processor of claim 1, further comprising a fifth logic to select a branch prediction signal in order of precedence from one of: the loop prediction signal, the second global prediction signal, the first global prediction signal, or the bimodal prediction signal.

17. The processor of claim 1, wherein at least one of the first, second, third, or fourth logic deallocate themselves in response to a correct prediction by a lower precedence predictor.

18. A method comprising:
generating a plurality of global predictions corresponding to a conditional branch instruction;
generating a bimodal prediction corresponding to the conditional branch instruction; and
generating a loop prediction corresponding to the conditional branch instruction.

19. The method of claim 18, further comprising selecting a branch prediction from one of: the plurality of global predictions, the bimodal prediction, or the loop prediction.

20. The method of claim 18, wherein generating the plurality of global predictions comprises:
generating a first global prediction corresponding to the instruction based on a first set of global branch history data; and
generating a second global prediction corresponding to the instruction based on a second set of global branch history data,
wherein the first set of global branch history data has a different size than the second set of global branch history data.

21. The method of claim 18, further comprising allocating an entry corresponding to a branch instruction in a loop array after detecting that a bimodal predictor is in a strong state.

22. The method of claim 18, further comprising updating data corresponding to one or more current predictions based on an outcome of a branch prediction.

23. A computing system comprising:
a memory to store a branch instruction;
a plurality of global predictors to generate a little global prediction and a big global prediction corresponding to the branch instruction;
a bimodal predictor to generate a bimodal prediction corresponding to the branch instruction; and
a loop predictor to generate a loop prediction corresponding to the branch instruction.

24. The system of claim 23, further comprising logic to allocate one or more entries corresponding to the branch instruction in one or more arrays coupled to the plurality of global predictors, the loop predictor, or the bimodal predictor in response to a branch misprediction.

25. The system of claim 23, further comprising logic to update data corresponding to one or more current predictions based on an outcome of a branch prediction corresponding to the branch instruction.

26. The system of claim 23, wherein a first one of the plurality of global predictors generate the little global prediction based on a first set of global branch history data and a second one of the plurality of global predictors generates the big global prediction based on a second set of global branch history data.

27. The system of claim 23, further comprising logic to generate a static prediction corresponding to the branch instruction.

28. The system of claim 23, further comprising a plurality of processor cores, wherein at least one of the plurality of processor cores comprises one or more of the bimodal predictor, at least one of the plurality of global predictors, or the loop predictor.

29. The system of claim 23, further comprising an audio device coupled to the memory.

30. The system of claim 23, wherein one or more of the bimodal predictor, at least one of the plurality of global predictors, or the loop predictor, a plurality of processor cores, or a shared cache are on a same integrated circuit die.
